(19) United States
(12) Patent Application Publication
(10) Pub. No.: US 2026/0270468 A1
(43) Pub. Date: Sep. 10, 2026

(54) IMAGE PROCESSING METHOD FOR MOTION ESTIMATION

(71) Applicant: Novatek Microelectronics Corp., Hsinchu (TW)

(72) Inventor: Ya-Lun Li, Hsinchu County (TW)

(73) Assignee: Novatek Microelectronics Corp., Hsinchu (TW)

(21) Appl. No.: 19/070,437

(22) Filed: Mar. 4, 2025

(51) Int. Cl. H04N 19/513; H04N 19/132; H04N 19/139; H04N 19/172; H04N 19/196

(52) U.S. Cl. CPC H04N 19/521; H04N 19/132; H04N 19/139; H04N 19/172; H04N 19/196

(57) ABSTRACT

An image processing method is proposed. The method includes to receive an I frame and generate a coordinate I-list corresponding to a first detected object in the I-frame and including a first coordinate candidate set having four coordinates, receive a P-frame following the I-frame and generate a coordinate P-list corresponding to a second detected object in the P-frame and including a second coordinate candidate set having four coordinates, generate at least one object region and an initial motion vector thereof of an interpolated frame between the I-frame and the P-frame based on the coordinate I-list and the coordinate P-list, and correct the initial motion vector to generate a corrected motion vector of the at least one object region of the interpolated frame.

### TECHNICAL FIELD

The disclosure relates to an image processing technique for motion estimation.

### BACKGROUND

Traditional non-AI-based motion vector estimation algorithms are based on fine details and the sum of absolute differences (SAD) between corresponding image blocks for object detection as well as motion vector convergence. However, such scheme requires two P-frames for frame interpolation and extensive hardware cost for data storage. AI-based object detection for motion vector estimation algorithms are based on object coordinate extraction as well as motion vector convergence. However, such scheme is not able to guarantee the acquisition of information from the second P frame and results in failure of frame interpolation. Moreover, object coordinate extraction is less accurate in scenarios involving fast-moving small object and results in inaccurate motion vector estimation.

### SUMMARY OF THE DISCLOSURE

To solve the prominent issues, an image processing method for motion estimation is proposed.

According to one of the exemplary embodiments, the method includes to receive an I frame and generate a coordinate I-list corresponding to a first detected object in the I-frame and including a first coordinate candidate set having four coordinates, receive a P-frame following the I-frame and generate a coordinate P-list corresponding to a second detected object in the P-frame and including a second coordinate candidate set having four coordinates, generate at least one object region and an initial motion vector thereof of an interpolated frame between the I-frame and the P-frame based on the coordinate I-list and the coordinate P-list, and correct the initial motion vector to generate a corrected motion vector of the at least one object region of the interpolated frame.

It should be understood, however, that this summary may not contain all of the aspect and embodiments of the disclosure and is therefore not meant to be limiting or restrictive in any manner. Also, the disclosure would include improvements and modifications which are obvious to one skilled in the art.

### BRIEF DESCRIPTION OF THE DRAWINGS

The accompanying drawings are included to provide a further understanding of the disclosure, and are incorporated in and constitute a part of this specification. The drawings illustrate embodiments of the disclosure and, together with the description, serve to explain the principles of the disclosure.

FIG. 1 illustrates a schematic diagram of an image processing apparatus in accordance with an exemplary embodiment of the disclosure.

FIG. 2 illustrates a flowchart of an image processing method in accordance with an exemplary embodiment of the disclosure.

FIG. 3 illustrates a schematic diagram of a coordinate processing scheme in accordance with an exemplary embodiment of the disclosure.

FIG. 4A and FIG. 4B illustrate how additional motion vectors are added in accordance with an exemplary embodiment of the disclosure

To make the above features and advantages of the application more comprehensible, several embodiments accompanied with drawings are described in detail as follows.

### DESCRIPTION OF THE EMBODIMENTS

Some embodiments of the disclosure will now be described more fully hereinafter with reference to the accompanying drawings, in which some, but not all embodiments of the application are shown. Indeed, various embodiments of the disclosure may be embodied in many different forms and should not be construed as limited to the embodiments set forth herein; rather, these embodiments are provided so that this disclosure will satisfy applicable legal requirements. Like reference numerals refer to like elements throughout.

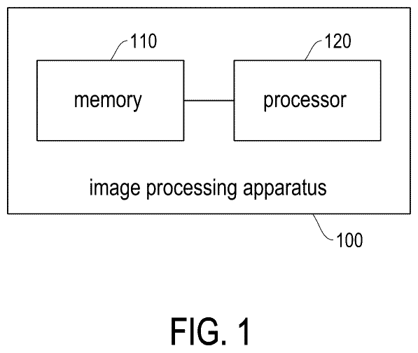

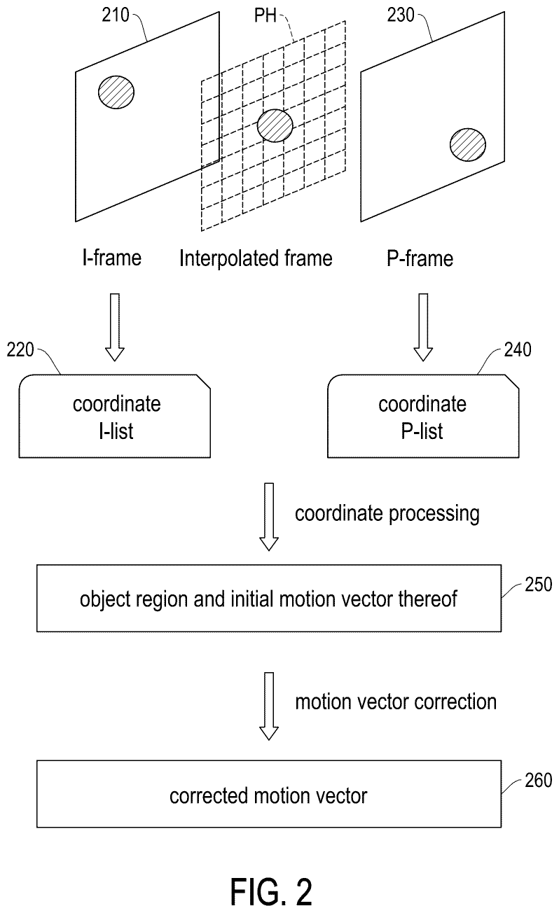

FIG. 1 illustrates a schematic diagram of an image processing apparatus in accordance with an exemplary embodiment of the disclosure. All components and configurations of the apparatus are first introduced in FIG. 1. The functionalities of the components are disclosed in more detail in conjunction with FIG. 2.

Referring to FIG. 1, an image processing apparatus 100 would include a memory 110 and a processor 120. The image processing apparatus 100 may be an electronic system or a computer system. The memory 110 may be many forms of random-access memory (RAM) such as a dynamic random-access memory (DRAM). The processor 120 may be one or more of a North Bridge, a South Bridge, a field programmable array (FPGA), a programmable logic device (PLD), an application specific integrated circuit (ASIC), other similar devices or integrated circuits, or a combination thereof. The processor 120 may also be a central processing unit (CPU), a programmable general purpose or special purpose microprocessor, a digital signal processor (DSP), a graphics processing unit (GPU), other similar devices or integrated circuits, or a combination thereof.

FIG. 2 illustrates a schematic flow diagram of an image processing method in accordance with an exemplary embodiment of the disclosure, where the steps of FIG. 2 could be implemented by the image processing apparatus 100 as illustrated in FIG. 1.

In this exemplary embodiment, assume that a time series of video frames including a fast-moving small object such as a ball is continuously received by the image processing apparatus 100. Moreover, assume that an AI-based model (e.g. CNN model) that is able to recognize certain objects or patterns is pre-trained and pre-stored in the memory 110.

Now referring to FIG. 2 in conjunction to FIG. 1, the processor 120 of the image processing apparatus 100 would receive an I-frame 210 from a time series of video frames and generate a coordinate I-list 220. Herein, the coordinate I-list 220 would include at least one coordinate candidate set, and each coordinate candidate set would include four coordinates. Each coordinate candidate set may represent a region of interest that includes a detected object identified from the I-frame 210 by the AI-based model, and the four coordinates may represent four vertices of the region of interest. In another embodiment, each coordinate candidate set may include more than four coordinates representing more information about the region of interest. The disclosure is not limited in this regard.

Next, the processor 120 of the image processing apparatus 100 would receive a P-frame 230 following the I-frame 210 from the time series of video frames and generate a coordinate P-list 240 in a similar fashion. That is, the coordinate P-list 240 would include at least one coordinate candidate set, and each coordinate candidate set would include four coordinates. Each coordinate candidate set may represent a region of interest that includes a detected object identified from the P-frame 230 by the AI-based model, and the four coordinates may represent four vertices of the region of interest.

Next, the processor 120 would generate at least one object region and an initial motion vector thereof 250 of an interpolated frame PH between the I-frame 210 and the P-frame 230 based on the coordinate I-list 220 and the coordinate P-list 240. It should be noted that, since the I-frame 210 and the P-frame 230 are processed independently, the coordinate I-list 220 and the coordinate P-list 240 may not have one-to-one correspondence, and therefore the coordinate I-list 220 and the coordinate P-list 240 would be subject to coordinate processing such that the processor 120 would perform matching on the coordinate I-list 220 and the coordinate P-list 240 to obtain at least one correspondence.

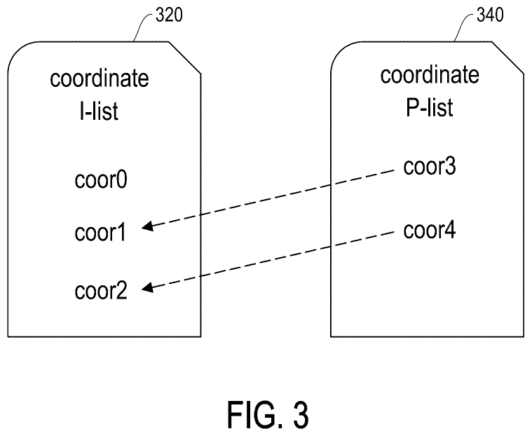

In the present exemplary embodiment, the processor 120 would use the coordinate list which contains fewer number of coordinate candidate sets as a master to perform matching. For example, FIG. 3 illustrates a schematic diagram of a coordinate processing scheme in accordance with an exemplary embodiment of the disclosure.

Referring to FIG. 3 in conjunction to FIG. 1, a coordinate I-list 320 includes three coordinate candidate sets coor0, coor1, and coor2, and a coordinate P-list 340 includes two coordinate candidate sets coor3 and coor4. Since the number of coordinate candidate sets in the coordinate P-list 340 is less than that in the coordinate I-list 320, the processor 120 would consider the coordinate P-list 340 as a master and search for a coordinate candidate set from the coordinate I-list 320 having a minimum distance with respect to each coordinate candidate set coor3 and coor4 in the coordinate P-list 340.

In this case, the coordinate candidate sets coor1 and coor2 in the coordinate I-list 320 are the coordinate candidate sets respectively having minimum distances from the coordinate candidate sets coor3 and coor4 in the coordinate P-list 340. Then, the coordinate candidate sets coor1 and coor3 would form a correspondence, and the coordinate candidate sets coor2 and coor4 would form another correspondence. The unmatched coordinate candidate set coor0 may be considered as false detection and may be discarded.

It should be understood that in another example, when the number of coordinate candidate sets in a coordinate P-list is greater than that in a coordinate I-list, the processor 120 would consider the coordinate I-list as a master and search for a coordinate candidate set from a coordinate P-list having a minimum distance with respect to each coordinate candidate set in the coordinate I-list. The details may be deduced by a skilled person per se based on FIG. 3 and will be omitted for brevity herein.

Referring back to FIG. 2, for easy demonstration and better understanding, one of the correspondences (referred to as “designated correspondence” hereafter) will be illustrated hereafter, and the designated correspondence would include “a first coordinate candidate set” from the coordinate I-list 220 and “a second coordinate candidate set” from the coordinate P-list 240. In terms of the interpolated frame PH, the processor 120 would compute four motion vectors respectively corresponding to four pairs of coordinates in the designated correspondence (referred to as “coordinate motion vectors” hereafter) and generate a designated object region of the interpolated frame PH based on the first coordinate candidate set and the four coordinate motion vectors. Herein, the designated object region of the interpolated frame PH corresponds to the region of interests in the I-frame and the P-frame. The processor 120 would also compute an initial motion vector of the designated object region of the interpolated frame PH based on the four coordinate motion vectors.

In detail, the four coordinate motion vectors for the designated correspondence may be expressed as the following Eq. (1):

$$mv\_x 0 = I\_left - P\_left$$

$$mv\_x1 = I\_right - P\_right$$

$$mv\_y0 = I\_top - P\_top$$

$$mv\_y1 = I\_bottom - P\_bottom$$

Herein, mv_x0, mv_x1, mv_y0, and mv_y1 denote the four coordinate motion vectors. I_left, I_right, I_top, and I_bottom denote the first designated coordinate set in the coordinate I-list 220, and P_left, P_right, P_top, and P-bottom denote the second designated coordinate set in the coordinate P-list 240.

Moreover, the designated object region of the interpolated frame PH may be expressed as the following Eq. (2):

$$PH\_Left = I\_Left - int ( ph\_k \times mv\_x0 / 128. )$$

$$PH\_Right = I\_Right - int ( ph\_k \times mv\_x 1 / 128. )$$

$$PH\_Top = I\_Top - int ( ph\_k \times mv\_y 0 / 128. )$$

$$PH\_Bottom = I\_Bottom - int ( ph\_k \times mv\_y 1 / 128. )$$

Herein, int denotes an integer operation. PH_Left, PH_Right, PH_Top, and PH_Bottom denote four vertices of the designated object region of the interpolated frame PH. Note that ph_k/128.0 represents the phase of the interpolated frame PH. For example, if the phase of the interpolated frame PH is ¼, then ph_k is equal to 32; if the phase of the interpolated frame PH is 2/4, then ph_k is equal to 64.

Now, the initial motion vector of the designated object region of the interpolated frame PH may be expressed as the following Eq. (3):

$$MV\_X = min / max / avg ( mv\_x 0 , mv\_x1 )$$

$$MV\_Y = min / max / avg ( mv\_y 0 , mv\_y1 )$$

Herein, MV_X denotes a horizontal component of the initial motion vector and may be a minimum, a maximum, or an average of two horizontal motion vectors, and MV_Y denotes a vertical component of the initial motion vector and may be a minimum, a maximum, or an average of two vertical motion vectors.

For precision and completeness, the processor 120 would then perform motion vector correction that corrects the initial motion vector to generate a corrected motion vector 260 of the object region of the interpolated frame PH in order to suppress any possible inaccurate detection result from the I-frame or the P-frame based on the AI-based model. In the present exemplary embodiment, the processor 120 would add multiple additional motion vectors to neighboring positions with respect to the initial motion vector and select an optimal motion vector, among the initial motion vector and the additional motion vectors, that minimizes a predetermined cost function (e.g. any cost function in the existing art) as the corrected motion vector 260.

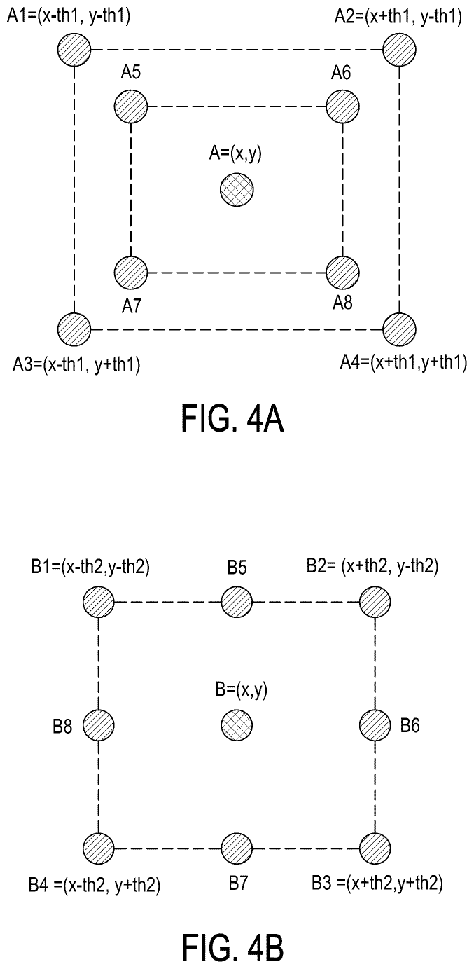

For example, FIG. 4A and FIG. 4B illustrate how additional motion vectors are added in accordance with an exemplary embodiment of the disclosure.

Referring to FIG. 4A, when the phase of an interpolated frame is zero (i.e. an I-frame), four additional motion vectors A1, A2, A3, and A4 are added to neighboring positions of an initial motion vector A=(x, y) on the interpolated frame, where:

$$A 1 = ( x - th 1 , y - th 1 )$$

$$A 2 = ( x + th 1 , y - th 1 )$$

$$A 3 = ( x - th 1 , y + th 1 )$$

$$A 4 = ( x + th 1 , y + th 1 )$$

Herein the value of th1 is a preset constant. Moreover, four additional motion vectors A5, A6, A7, and A8 may be respectively added at the midpoints between the initial motion vector and the additional motion vectors A1, A2, A3, and A4. From another perspective, the additional motion vectors A1~A8 may form two concentric squares with respect to the initial motion vector A of the interpolated frame.

Referring to FIG. 4B, when the phase of the interpolated frame is non-zero, eight additional motion vectors B1~B8 are added to neighboring positions of an initial motion vector B=(x, y) of the interpolated frame, where:

$$B 1 = ( x - th 2 , y - th 2 )$$

$$B 2 = ( x + th 2 , y - th 2 )$$

$$B 3 = ( x + th 2 , y + th 2 )$$

$$B 4 = ( x - th 2 , y + th 2 )$$

Herein, the value of th2 is a preset constant different from th1 and may be varied based on the phase of the interpolated frame. For example, if the interpolated frame is closer to the P-frame (i.e. larger phase), the spacing between the additional motion vectors becomes smaller (i.e. smaller th2). Moreover, additional motion vectors B5, B6, B7, and B8 are added at the midpoints between every two additional motion vectors B1~B4. From another perspective, the additional motion vectors B1~B8 are equally spaced and form a square around the initial motion vector MV of the interpolated frame.

The optimal motion vector (i.e. the corrected motion vector) among the initial motion vector and the additional motion vectors would ultimately allow a smoother and more fluid motion in a video. Overall, the proposed image processing method provides promising motion estimation, in particular to a video including fast-moving objects, that remedies the issues on poor motion vector convergence in the existing motion vector estimation schemes.

No element, act, or instruction used in the detailed description of disclosed embodiments of the present application should be construed as absolutely critical or essential to the present disclosure unless explicitly described as such. Also, as used herein, each of the indefinite articles “a” and “an” could include more than one item. If only one item is intended, the terms “a single” or similar languages would be used. Furthermore, the terms “any of” followed by a listing of a plurality of items and/or a plurality of categories of items, as used herein, are intended to include “any of”, “any combination of”, “any multiple of”, and/or “any combination of multiples of the items and/or the categories of items, individually or in conjunction with other items and/or other categories of items. Further, as used herein, the term “set” is intended to include any number of items, including zero. Further, as used herein, the term “number” is intended to include any number, including zero.

It will be apparent to those skilled in the art that various modifications and variations can be made to the structure of the disclosed embodiments without departing from the scope or spirit of the disclosure. In view of the foregoing, it is intended that the disclosure cover modifications and variations of this disclosure provided they fall within the scope of the following claims and their equivalents.

What is claimed is:

1. An image processing method executed by an image processing apparatus, comprising:
receiving an I-frame and generating a coordinate I-list corresponding to a first detected object in the I-frame and comprising a first coordinate candidate set having four coordinates, by the image processing apparatus;
receiving a P-frame following the I-frame and generating a coordinate P-list corresponding to a second detected object in the P-frame and comprising a second coordinate candidate set having four coordinates, by the image processing apparatus;
generating at least one object region and an initial motion vector thereof of an interpolated frame between the I-frame and the P-frame based on the coordinate I-list and the coordinate P-list, by the image processing apparatus; and
correcting the initial motion vector to generate a corrected motion vector of the at least one object region of the interpolated frame, by the image processing apparatus.

2. The image processing method according to claim 1, wherein after generating the coordinate I-list and the coordinate P-list, the method further comprises:
performing coordinate processing by performing matching on the coordinate I-list and the coordinate P-list to obtain at least one correspondence, by the image processing apparatus, wherein the at least one correspondence comprises a designated correspondence having the first coordinate candidate set from the coordinate I-list and the second coordinate candidate set from the coordinate P-list.

3. The image processing method according to claim 2, the step of performing matching on the coordinate I-list and the coordinate P-list comprises:
in response to a number of coordinate candidate sets in the coordinate P-list being less than a number of coordinate candidate sets in the coordinate I-list, searching for a coordinate candidate set from the coordinate I-list having a minimum distance with respect to the second coordinate candidate set in the coordinate P-list to form a correspondence, by the image processing apparatus; and
in response to the number of the coordinate candidate sets in the coordinate P-list being greater than the number of the coordinate candidate sets in the coordinate I-list, searching for a coordinate candidate set from the coordinate P-list having a minimum distance with respect to the first coordinate candidate set in the coordinate I-list to form another correspondence.

4. The image processing method according to claim 2, wherein the step of generating the at least one object region and the initial motion vector thereof of the interpolated frame between the I-frame and the P-frame based on the coordinate I-list and the coordinate P-list comprises:
computing four coordinate motion vectors for the designated correspondence, by the image processing apparatus;
generating a designated object region among the at least one object region of the interpolated frame based on the first coordinate candidate set and the four coordinate motion vectors, by the image processing apparatus; and
generating the initial motion vector of the designated object region of the interpolated frame based on the four coordinate motion vectors, by the image processing apparatus.

5. The image processing method according to claim 4,
wherein the four coordinate motion vectors comprise two horizontal motion vectors and two vertical motion vectors,
wherein a horizontal component of the initial motion vector is generated based on the two horizontal motion vectors, and
wherein a vertical component of the initial motion vector is generated based on the two vertical motion vectors.

6. The image processing method according to claim 5,
wherein the horizontal component of the initial motion vector is an average, a minimum, or a maximum of the two horizontal motion vectors, and
wherein the vertical component of the initial motion vector is an average, a minimum, or a maximum of the two vertical motion vectors.

7. The image processing method according to claim 1, wherein the step of correcting the initial motion vector to generate the corrected motion vector of the at least one object region of the interpolated frame comprises:
adding a plurality of additional motion vectors to neighboring positions of the initial motion vector, by the image processing apparatus; and
selecting an optimal motion vector among the initial motion vector and the plurality of additional motion vectors that minimizes a predetermined cost function as the corrected motion vector, by the image processing apparatus.

8. The image processing method according to claim 7,
wherein the initial motion vector is positioned at a center of the plurality of additional motion vectors.

9. The image processing method according to claim 8,
wherein the closer the interpolated frame is to the P-frame, the closer the plurality of additional motion vectors are away from the initial motion vector.
